(19) United States
(12) Patent Application Publication
(10) Pub. No.: US 2024/0356420 A1
(43) Pub. Date: Oct. 24, 2024

(54) GYRAL MOTOR

(71) Applicant: William E. Gregory, Los Lunas, NM (US)

(72) Inventor: William E. Gregory, Los Lunas, NM (US)

(21) Appl. No.: 18/607,447

(22) Filed: Mar. 16, 2024

Related U.S. Application Data
(60) Provisional application No. 63/454,145, filed on Mar. 23, 2023.

(51) Int. Cl. H02K 19/02; H02K 5/04

(52) U.S. Cl. CPC H02K 19/02; H02K 5/04

(57) ABSTRACT

A gyral motor and a method of operating the gyral motor can include a group of momentum wheels wherein each momentum wheel among the group of momentum wheels can include a cylinder within which a piston is located and enclosed within the cylinder by a cylinder cover, and one or more electromagnets, wherein the momentum wheels while spinning are self-balanced until the electromagnet is activated. Each momentum wheel functions as a propulsive momentum wheel that can facilitate propulsion of an object such as, for example, a spacecraft.

### CROSS-REFERENCE TO PROVISIONAL APPLICATION

This patent application claims priority under 35 U.S.C. § 119(e) to U.S. Provisional Patent Application Ser. No. 63/454,145 entitled “Gyral Motor,” which was filed on Mar. 23, 2023, the disclosure of which is incorporated herein by reference in its entirety.

### TECHNICAL FIELD

Embodiments are related to propulsion methods, systems, and devices. Embodiments also relate to the management of the center of mass in a propulsion system. Embodiments further relate to a propulsion system referred to as a gyral motor that include a group of propulsive momentum wheels that can facilitate propulsion. Embodiments also relate to spacecraft propulsion systems.

### BACKGROUND

Conventional rocket and propulsion technologies typically employ liquid or solid propulsion systems, with liquid rockets mixing and igniting separate propellants, and solid rockets relying on preloaded propellants for thrust. The use of multistage rockets allows for efficient fuel consumption as stages are jettisoned when depleted.

Furthermore, guidance and control systems ensure rockets follow precise trajectories, while payload fairings protect the cargo during launch. Rockets are launched from specialized facilities, and materials like lightweight composites are used in their construction to optimize performance. Propellants are loaded shortly before launch, and telemetry systems monitor the rocket's progress in real time. For crewed missions, heat shields and parachutes facilitate reentry and landing. Despite the emergence of newer technologies, these conventional space rocket technologies continue to underpin space exploration and have enabled endeavors ranging from satellite deployment to human lunar missions.

Current space propulsion technologies used in space can be broadly categorized into two main types: chemical propulsion and electric propulsion. Chemical propulsion systems, like those used in traditional rockets, are widely employed for launching payloads into space and for providing initial thrust during spacecraft launches. They offer high thrust levels and are suitable for missions that require rapid acceleration. However, they have limitations, such as limited fuel efficiency and the need for large propellant tanks, which can limit the payload capacity and range of spacecraft. Additionally, chemical propulsion systems are not well-suited for long-duration missions, as their fuel stores can be quickly depleted.

Electric propulsion systems, on the other hand, are increasingly being used for deep-space missions and satellite station-keeping. These systems are more fuel-efficient and provide a much higher specific impulse (thrust per unit of propellant) than chemical rockets, allowing spacecraft to reach higher speeds over time. However, electric propulsion systems have limitations related to their relatively low thrust levels, which means they may require longer durations to achieve significant velocity changes. This makes them less suitable for launching payloads from Earth's surface, but ideal for missions where efficiency and extended operation in space are crucial. They are also sensitive to power constraints, relying on electricity from solar panels or nuclear sources.

Current space propulsion technologies offer a range of capabilities, but they also come with their own set of problems and limitations. While chemical propulsion systems provide high thrust but are inefficient for long-duration missions, electric propulsion systems are more efficient but have lower thrust levels and power requirements. Finding the right propulsion system depends on the specific mission requirements and trade-offs between factors like thrust, efficiency, and power constraints.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for an improved propulsion system and method.

It is another aspect of the embodiments to provide for a gyral motor that incorporate the use of propulsive momentum wheels that can facilitate propulsion.

It is a further aspect of the embodiments to provide for devices, methods and systems for facilitating propulsion based on a propulsion approach that avoids oscillation.

The aforementioned aspects and other objectives and advantages can now be achieved as described herein. In an embodiment, a gyral motor can be implemented, which can include a plurality of momentum wheels wherein each momentum wheel among the plurality of momentum wheels comprises a cylinder within which a piston is located and enclosed within the cylinder by a cylinder cover; and at least one electromagnet, wherein the momentum wheels among the plurality of momentum wheels while spinning are self-balanced until the electromagnet is activated.

In an embodiment, each momentum wheel among the plurality of momentum wheels can function as a propulsive momentum wheel.

In an embodiment of the gyral motor, each momentum wheel among the plurality of momentum wheels can facilitate propulsion.

In an embodiment of the gyral motor, plurality of momentum wheels can convert an angular system to an angular system with vector.

In an embodiment of the gyral motor, the plurality of momentum wheels can include at least two momentum wheels that can function as two balanced and counter-rotating, aligned moment wheels during the spinning of the plurality of momentum wheels.

In an embodiment of the gyral motor, a center of mass can be separated from a center of geometry when the at least one electromagnet is activated and the center of mass can be united back in line with the center of geometry after one π radian.

In an embodiment of the gyral motor, each momentum wheel among the plurality of momentum wheels can shift into a vector mode for one π radian and a cycle period repeats.

An embodiment of the gyral motor can include two incompressible liquids positioned on each side of the piston.

In an embodiment of the gyral motor, each of the two incompressible liquids can comprise contrasting densities.

In an embodiment of the gyral motor, the piston can float between the two incompressible liquids.

In an embodiment, the gyral motor can move curvilinearly through cycle periods.

In an embodiment of the gyral motor, the electromagnet(s) can facilitate movement of the piston asymmetrically and can then bring the piston back into symmetry.

In another embodiment, a gyral motor, can include: a plurality of momentum wheels wherein each momentum wheel among the plurality of momentum wheels comprises a cylinder within which a piston is located and enclosed within the cylinder by a cylinder cover; at least one electromagnet, wherein each of the plurality of momentum wheels while spinning are self-balanced until the at least one electromagnet is activated, wherein the plurality of momentum wheels comprise balanced and counter-rotating, aligned momentum wheels during the spinning of the plurality of momentum wheels; and two incompressible liquids positioned on each side of the piston, wherein each of the two incompressible liquids comprise contrasting densities and wherein the piston floats between the two incompressible liquids.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a schematic diagram depicting basic principles of a gyral motor, in accordance with an embodiment;

FIG. 2 illustrates a perspective view of a gyral motor composed of two momentum wheels, in accordance with an embodiment;

FIG. 3 illustrates a perspective view of a piston and cylinders of a gyral motor, in accordance with an embodiment;

FIG. 4 illustrates a graph depicting a curvilinear path of momentum wheels during ½ cycles, in accordance with an embodiment;

FIG. 5A and FIG. 5B illustrate a top views of a momentum wheel during a spinning activity at a first time T1 and a second time T2, in accordance with an embodiment;

FIG. 6 illustrates a schematic diagram depicting the center of mass of a disk, in accordance with an embodiment; and

FIG. 7 illustrates a schematic diagram depicting the centrifugal force and tangential velocity from the angular rate, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, the phrase “at least one widget” can refer to “one or more widgets.”

The disclosed embodiments relate to a propulsion system that can be referred to as a gyral motor. This motor, discussed in greater detail herein, presents several advantages compared to traditional propulsion methods. Notably, it operates on electrical energy, producing no sound or chemical pollution. Additionally, constructing a gyral motor is less complex than building rockets. The gyral motor can be implemented in a variety of applications including, for example, ground-based lift systems to lift a spacecraft from the earth into space or as part of a space propulsion system for a spacecraft in space.

In practical terms, a spacecraft equipped with a gyral motor can achieve acceleration without reaching escape velocity, as long as there is a power source. The gyral motor can also enable a spacecraft to hover by counterbalancing Earth's gravity with a linear Newton force pulling the spacecraft in the opposite direction, all achieved at a minimal force of gravity (little g).

Importantly, the gyral motor adheres to fundamental physical principles. It does not violate the conservation of momentum, Newton's third law of motion, or the first and second laws of thermodynamics. Moreover, the gyral motor has the capability to accelerate a spacecraft at rates exceeding 10 meters per second squared, even in environments with friction or without mass ejection, such as microgravity.

Crucially, the use of a gyral motor in space does not adversely affect spacecraft occupants due to weightlessness, as the motor can continuously accelerate or decelerate at a minimal force of gravity. However, it is noted that the gyral motor does have an upper-speed limit, determined by gamma and Lorentz transformations, attributed to the energy required to increase inertia at relativistic speeds.

A gyral motor is a novel device incorporating multiple momentum wheels, each housing a piston within a cylinder covered by a cylinder cover. In addition, the gyral motor features at least one electromagnet. As the momentum wheels spin, they exhibit inherent self-balancing characteristics, which persist until the activation of the electromagnet. These momentum wheels can serve as propulsive elements, facilitating propulsion and converting an angular system into one with a vector. The gyral motor may include pairs of balanced and counter-rotating moment wheels among the plurality.

Upon electromagnet activation, the center of mass undergoes separation from the center of geometry, with reunification occurring after one π radian. Additionally, at least one momentum wheel can shift into a vector mode for one π radian, marking the repetition of a cycle period. Notably, the gyral motor may incorporate two incompressible liquids with contrasting densities on each side of the piston, causing the piston to float between them. This unique design enables curvilinear movement throughout cycle periods. The electromagnet's role extends to asymmetrically moving the piston and subsequently restoring it to symmetry.

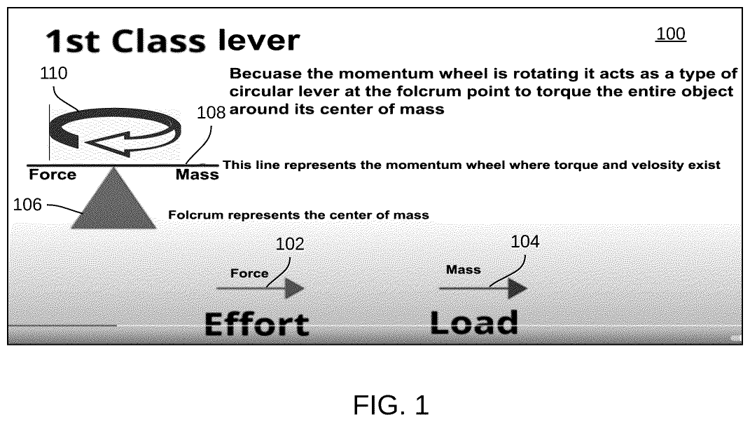

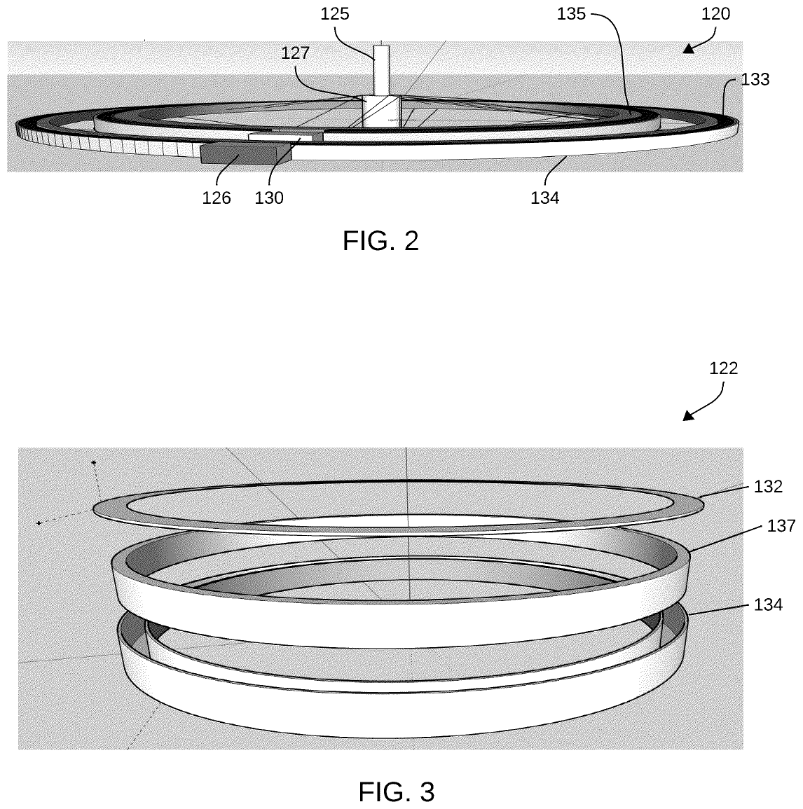

FIG. 1 illustrates a schematic diagram 100 depicting basic principles of a gyral motor, in accordance with an embodiment. The schematic diagram shown in FIG. 1 relates to a momentum wheel such as momentum wheel 133 shown and described herein with respect to, for example, FIG. 2 and FIG. 3. Such momentum wheels can form a crucial component of a gyral motor, such as the gyral motor 120 illustrated and described herein

Because the momentum wheel 133 rotates, it acts as a type of circular lever at the fulcrum point to torque the entire object around its center of mass. In FIG. 1 arrow 102 indicates force with respect to effort and arrow 104 is representative of mass with respect to a load. Line 108 shown in FIG. 1 represents the momentum wheel where torque and velocity exist. In addition, a fulcrum 106 is shown with respect to the line 108, while circular arrow 110 represents circular motion or circular movement.

The gyral motor concept depicted in FIG. 1 is based on Archimedes' principles, particularly the law of the lever. However, it deviates by employing a dynamic hyperspace point as the fulcrum inside the object being moved. This point is termed the center of mass (which is paradoxically devoid of actual mass). The gyral motor concept incorporates additional principles, such as Pascal's Principles, Newtonian mechanics, and Einstein's Equivalence principle.

In simpler terms, the gyral motor utilizes fundamental principles of physics to function. The center of mass, where the fulcrum is located, is not a physical point with mass but a dynamic reference within the object. This design is influenced by Archimedes' law of the lever, where the fulcrum plays a crucial role in the mechanical advantage.

The system of the disclosed gyral motor has the ability to store energy through two balanced and counter-rotating momentum wheels with only magnitude, as depicted in FIG. 2. These wheels, operating in tandem, can contribute to the efficient functioning of the gyral motor. The utilization of principles from Pascal, Newton, and Einstein enhances the overall performance and energy storage capabilities of this innovative motor system.

FIG. 2 illustrates a perspective view of a gyral motor 120 composed of a group of momentum wheels 133 and 135 in accordance with an embodiment. The gyral motor 120 can include the momentum wheels 133 and 135, which may comprise a cylinder 134 and a piston 137 located within the cylinder 134 (note that the piston 137 is not shown in FIG. 2 but is depicted in FIG. 3). The momentum wheel 133 can function as the outer momentum wheel and the momentum wheel 135 can function as the inner momentum wheel. It can be appreciated that gyral motor 120 can include one or more momentum wheels such momentum wheels 133 and 135 and that each momentum wheel may have a similar configuration.

The center of the gyral motor 120 can include a first cylindrically shaped portion comprising the rotor 125 of the gyral motor 120 and which connects to the stator 127 of the gyral motor 120. The rotor 125 and the stator 127 can spin in opposite directions. A number of spokes extend from the stator 127 and connect to the inner momentum wheel 135. An extended section shown in FIG. 2 constitutes an electromagnet 126 and another extended section constitutes another electromagnet 130.

The electromagnet 130 may be located opposite the electromagnetic 126. Although not shown in the figure, it can be appreciated another set of similar electromagnetics may be installed on the other side of the gyral motor 120 opposite the location of electromagnets 126 and 130. As discussed below, a piston can float between liquids (e.g., machine oil and mercury) having contrasting densities. Each momentum wheel may be implemented with a similar configuration (e.g., with a similar piston arrangement, etc.).

The gyral motor 120 shown in FIG. 2 can take advantage of everyday materials and existing technologies to create continuous acceleration in, for example, a spacecraft until gamma increases to the point where the energy required to increase linear motion (p=mv, a force acting on its mass to keep accelerating it as it reaches relativistic speeds where the gamma, Lorentz transformation in relativity is a limiting factor). The gyral motor 120 is scalable and silent and uses half-cycle periodic static unbalance.

The gyral motor 120, featured in FIG. 2, has the potential to harness common materials and existing technologies to achieve sustained acceleration, particularly in applications like spacecraft propulsion. This acceleration continues until gamma, a factor indicating relativistic speeds, reaches a critical point where additional energy is required to further increase linear motion. This demand arises from the force (p=mv) acting on the mass of the spacecraft, driving continuous acceleration even as it approaches relativistic speeds—where the Lorentz transformation (gamma) becomes a limiting factor.

What makes the gyral motor 120 notable is its scalability, quiet operation, and utilization of half-cycle periodic static unbalance. This design characteristic enhances its efficiency and contributes to its adaptability for various applications.

FIG. 3 illustrates a perspective view 122 of the piston 137 and the cylinder 134 of the gyral motor 120 shown in FIG. 2, in accordance with an embodiment. The components shown in FIG. 3 are also shown in FIG. 2 with the addition of a cylinder cover 132 shown in FIG. 3. It should be appreciated that the design described herein can include the use of electromagnets or electromagnetic components. Examples of such electromagnets or electromagnetic components are shown in FIG. 5A and FIG. 5B (e.g., see electromagnets 126, 130).

The gyral motor 120 can thus be composed of a set of momentum wheels, with each wheel having a cylinder containing a piston. Each cylinder may be sealed by a cylinder cover such as the cylinder cover 132. Additionally, the system of gyral motor 120 can include one or more electromagnets. When the momentum wheels spin, they maintain self-balance within the group until the electromagnet is activated. Each momentum wheel serves as a propulsive element, contributing to the overall propulsion of the system. It should be appreciated that the arrangement shown in FIG. 3 for momentum wheel 133 and its associated components may be similarly implemented for momentum wheel 135.

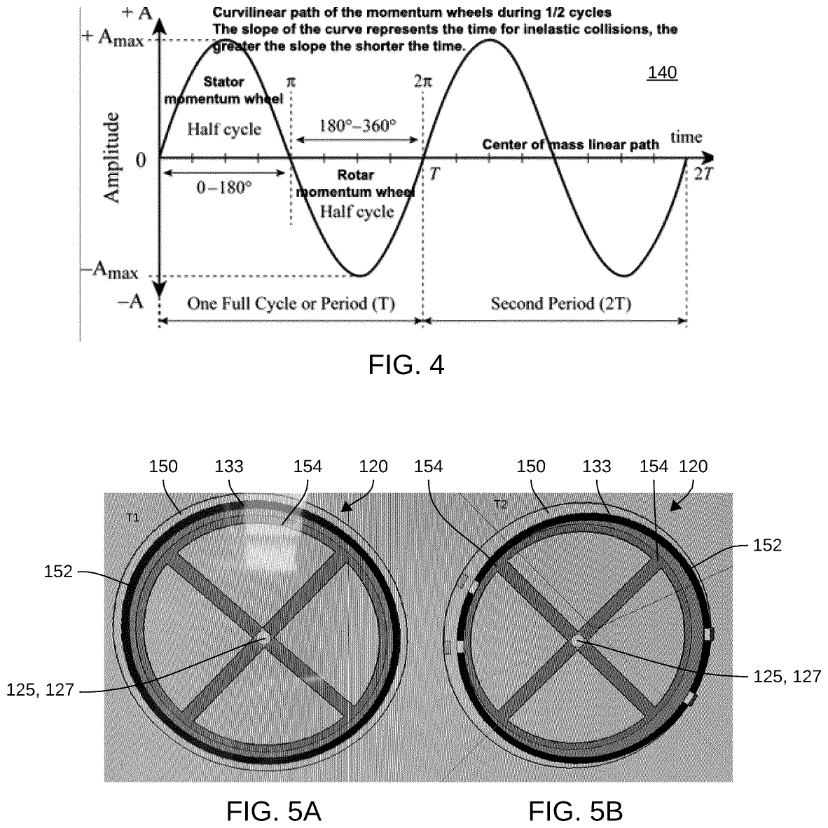

FIG. 4 illustrates a graph 140 depicting a curvilinear path of momentum wheels during ½ cycles, in accordance with an embodiment. The graph 140 indicates a curvilinear path of a momentum wheel during one-half cycles with the slope of the curve representing the for inelastic collisions, wherein the greater the slope, the shorter the time. The center of mass is separated from the center of geometry when one of the electromagnets is activated, giving the gyral motor its magnitude and a vector. The center of mass is then united back in line with the center of geometry after one π radian.

The other rotating wheel goes into vector mode for one π radian, and the cycle period repeats. This creates a square wave path for the disk motor with a linear path for the center of mass through the square wave motor movement pattern. The gyral motor can include two Incompressible liquids, one on each side of the piston 130 for example, with mercury on the outside with a density of, for example, 13.5 grams per cc and light machine oil with a density of 1 gram per cc on the inside between the inner part of the piston 130 and the inner part of the cylinder wall. These features are illustrated in FIG. 5A and FIG. 5B.

FIG. 5A and FIG. 5B illustrate a top views of the momentum wheel 133 during a spinning activity at a first time T1 and a second time T2, in accordance with an embodiment. In the configuration shown in FIG. 5A and FIG. 5B, mercury 150 is located on one side of the momentum wheel 133 and machine oil 152 is located on the other side of the momentum wheel 133. An interior or inside rim 154 is positioned centrally within the gyral motor configuration.

As discussed previously, the piston can float between liquids (e.g., machine oil and mercury) having contrasting densities. While spinning, the momentum wheels are self-balanced until an electromagnet is activated. The movement of the center of mass and the piston are drawn to the outer inside wall of, for example, the cylinder, 134 causing the unbalance returning the center of mass to the center of geometry unification, placing the momentum wheel 133 back in magnitude scaler mode. The device/system moves curvilinearly through the cycle periods as discussed above.

The desired propulsion is in small but constant spin pulses. We can use electromagnets to cause an inelastic collision between the cylinder and piston while the device rotates. The short distance of the collision gives a multiple greater change in the position of the center of mass. The disk motor rotates 180° around the new center of mass, giving it a vector from that momentum wheel before switching to the vector and magnitude mode on the other momentum wheel. Load capacity and position reduce the center of the mass movement. In a spacecraft implementation, the passenger compartment can be implemented on coaster bearings attached somewhere on the main axis and kept balanced.

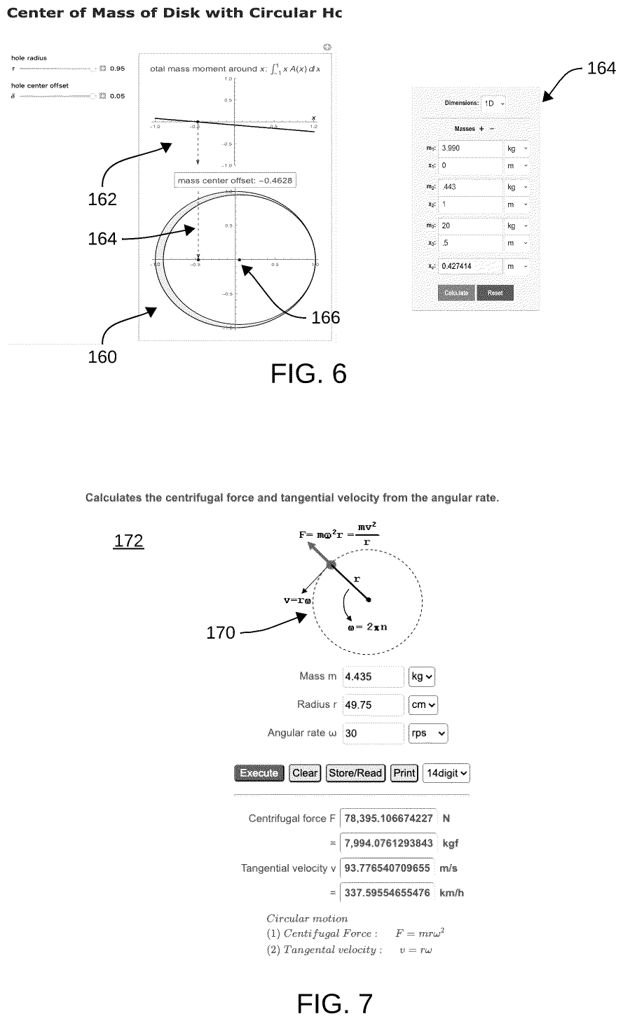

FIG. 6 illustrates a schematic diagram 160 depicting the center of mass of a disk, in accordance with an embodiment. A graph 162 accompanies the schematic diagram 160 along with a legend 164 containing example parameters. It should be appreciated the configuration shown in FIG. 6 and its specific numbers and parameters is provided for illustrative purposes only and should not be considered a limiting feature of the disclosed embodiments. The schematic diagram 160 shown in FIG. 6 demonstrates a mass center offset with the center of mass initially indicated by dashed line 166 and the offset to center of mass 166. That is, the center of mass 166 was located in the middle until offset by 0.5.

FIG. 7 illustrates a schematic diagram 172 depicting the centrifugal force and tangential velocity from the angular rate, in accordance with an embodiment. The schematic diagram 172 shown in FIG. 7 demonstrates circular motion including centrifugal force and tangential velocity with respect to example parameters of mass, radius and angular rate.

A method of configuring and operating the gyral motor 120 can involve providing a configuration of momentum wheels, wherein each momentum wheel within this configuration includes a cylinder housing a piston, the piston enclosed within the cylinder by a cylinder cover. Additionally, at least one electromagnet can be introduced into the system. The initiation of the spinning of the momentum wheels is a key aspect of this configuration, with self-balance maintained among the momentum wheels until the electromagnet is activated.

A method of configuring and operating the gyral motor 120 can further involve configuring each momentum wheel within the plurality as a propulsive momentum wheel. This specific configuration can enhance the gyral motor's functionality and contributes to its role in the overall propulsion of the system. Additional method steps can involve utilizing each momentum wheel within the plurality to actively facilitate propulsion. This feature underscores the practical application of the gyral motor in driving the forward motion of the system. An integral aspect of the method can include the conversion of an angular system within the plurality of momentum wheels to an angular system with a vector. This transformation enhances the versatility and effectiveness of the gyral motor.

This method can also incorporate the use of at least two momentum wheels, ensuring that these wheels are balanced and counter-rotating. This specific arrangement contributes to the optimal functioning of the gyral motor during the spinning process. Upon activation of the electromagnet, the method can include additional steps or operations such as dynamically manipulating the center of mass, causing a temporary separation from the center of geometry. Subsequently, the center of mass can be reunited back in line with the center of geometry after a defined angular displacement of one π radian. A notable feature of the method is the cycling of at least one momentum wheel within the plurality into a vector mode for one π radian. This cyclical process can repeat within the designated cycle periods of the gyral motor operation.

Other features of this method can include the incorporation of two incompressible liquids positioned on each side of the piston within the momentum wheel. Within the two incompressible liquids, the method can further involve configuring each liquid with contrasting densities. In addition, the piston within the momentum wheel can be designed to float between the two incompressible liquids. Another step or operation can involve curvilinear movement of the gyral motor throughout its cycle periods. Finally, this method can utilize the activated electromagnet to facilitate an asymmetric movement of the piston, followed by a controlled return to symmetry.

It can be appreciated that the gyral motor 120 presents a versatile and innovative system that can be adapted for effective use in propulsion applications, including not limited to spacecraft propulsion. The distinct features of the gyral motor and its components lend themselves to enhancing the efficiency and performance of propulsion systems in the context of space exploration.

The gyral motor's momentum wheels are configured as propulsive elements. This design ensures that each momentum wheel actively contributes to the propulsion of the spacecraft. As these wheels spin, they generate propulsive forces, which can be harnessed to drive the linear motion of the spacecraft. The inclusion of at least two momentum wheels that are balanced and counter-rotating is crucial for spacecraft propulsion. This configuration provides a stable and controlled spinning motion, minimizing undesired effects and ensuring the spacecraft's trajectory remains predictable. The gyral motor's ability to convert the angular system to an angular system with a vector is advantageous for spacecraft maneuverability. This transformation allows for more precise control over the spacecraft's orientation and direction during propulsion.

Furthermore, the dynamic manipulation of the center of mass, as facilitated by the activated electromagnet, can become a strategic tool for spacecraft propulsion. By selectively adjusting the center of mass, the gyral motor can optimize the spacecraft's stability and responsiveness to propulsion forces. The cyclical transition of at least one momentum wheel into a vector mode can introduce a periodic variation in the gyral motor's operation. This feature can be harnessed to modulate the spacecraft's propulsion intensity or direction periodically, allowing for advanced control strategies during space travel.

The use of incompressible liquids on each side of the piston contributes to the overall balance and stability of the gyral motor. In a spacecraft, this configuration minimizes vibrations and oscillations, ensuring a smoother and more controlled propulsion experience. In addition, the gyral motor's ability to move curvilinearly through cycle periods is particularly beneficial for spacecraft navigation. This movement pattern allows for more dynamic and flexible trajectory adjustments, making it well-suited for navigating the complex conditions of outer space.

The electromagnet's role in facilitating asymmetric piston movement and subsequent return to symmetry can be employed strategically for spacecraft propulsion adjustments. This controlled asymmetry can provide a mechanism for fine-tuning the propulsion forces applied to the spacecraft. By integrating the gyral motor into a spacecraft's propulsion system, these features collectively can contribute to an adaptable and efficient means of space travel. The gyral motor's scalability, silent operation, and utilization of fundamental principles in physics make it a promising candidate for advancing propulsion technologies in the realm of space exploration.

It should be appreciated that the gyral motor offers a number of features that can facilitate the prevention of oscillation. For example, the presence of incompressible liquids and pistons within each momentum wheel helps in providing stability. The contrasting densities of the liquids may contribute to the balancing effect. In addition, the self-balancing aspect of the momentum wheels is maintained while spinning. When needed, the electromagnet can be activated to alter the balance, likely for controlled movement or to introduce asymmetry. The arrangement of incompressible liquids on each side of the piston can assist, however, in maintaining stability and preventing oscillation. Furthermore, the inclusion of propulsive momentum wheels can be provided not just for balancing but also for providing propulsion, which can enhance the overall functionality and efficiency of the gyral motor.

The activation of the electromagnet introduces controlled asymmetry, and subsequent reunification of the center of mass and center of geometry can provide a dynamic balancing mechanism to prevent sustained oscillation. These features collectively or individual can contribute to the gyral motor's stability and control, preventing unwanted oscillations through a combination of self-balancing, asymmetry control, and the use of incompressible liquids.

Note that there may be some unknown variables that need to be taken into account in some embodiment. The biggest variable may involve the case when two counter-spinning momentum wheels spinning on the same axis will require a separate telemetry to keep it stable and gyroscopic. In other words, there may be no procession or gyroscopic stability when this happens and may need to be addressed by another telemetry add on or the two momentum wheels may need to separate for each momentum wheel to have procession and gyroscopic stability. They may work in separated pairs coming together occasionally to recharge their spin in Og.

The gyral motor 120 represents a groundbreaking advancement in propulsion technology, particularly suited for spacecraft applications. By configuring momentum wheels as propulsive elements and employing balanced, counter-rotating pairs, the gyral motor ensures stable and controlled propulsion. Its ability to convert angular systems, dynamically manipulate the center of mass, and transition momentum wheels into vector modes enables precise maneuverability and optimized propulsion forces. The incorporation of incompressible liquids and strategic electromagnet activation further enhances stability and control, mitigating oscillations and ensuring reliable operation. While challenges such as counter-spinning momentum wheels on the same axis necessitate additional considerations, the gyral motor's fundamental principles and adaptable design promise to revolutionize propulsion in the realm of space exploration.

Based on the foregoing, it can be appreciated that a number of different embodiments are disclosed herein. In an embodiment, a gyral motor can include a plurality of momentum wheels wherein each momentum wheel among the plurality of momentum wheels comprises a cylinder within which a piston is located and enclosed within the cylinder by a cylinder cover; and at least one electromagnet, wherein the momentum wheels among the plurality of momentum wheels while spinning are self-balanced until the electromagnet is activated.

In an embodiment, each momentum wheel among the plurality of momentum wheels can comprise a propulsive momentum wheel.

In an embodiment, each momentum wheel among the plurality of momentum wheels can facilitate propulsion.

In an embodiment, the plurality of momentum wheels can convert an angular system to an angular system with vector.

In an embodiment, the plurality of momentum wheels can include at least two momentum wheels that can comprise two balanced and counter-rotating, aligned moment wheels during the spinning of the plurality of momentum wheels.

In an embodiment, the center of mass can be separated from the center of geometry when the at least one electromagnet can be activated and the center of mass can be united back in line with the center of geometry after one π radian.

In an embodiment, at least one momentum wheel among the plurality of momentum wheels can shift into a vector mode for one π radian and a cycle period repeats.

In an embodiment, two incompressible liquids can be positioned on each side of the piston.

In an embodiment, each of the two incompressible liquids can comprise contrasting densities.

In an embodiment, the piston can float between the two incompressible liquids.

In an embodiment, the gyral motor can move curvilinearly through cycle periods.

In an embodiment, the at least one electromagnet can facilitate a movement of the piston asymmetrically and can then bring the piston back into symmetry.

In an embodiment, the plurality of momentum wheels can comprise one or more outer momentum wheels and one or more inner momentum wheels.

In an embodiment, a gyral motor can comprise: a plurality of momentum wheels wherein each momentum wheel among the plurality of momentum wheels comprises a cylinder within which a piston is located and enclosed within the cylinder by a cylinder cover; at least one electromagnet, wherein each of the plurality of momentum wheels while spinning are self-balanced until the at least one electromagnet is activated, wherein the plurality of momentum wheels comprise balanced and counter-rotating, aligned momentum wheels during the spinning of the plurality of momentum wheels; and two incompressible liquids positioned on each side of the piston, wherein each of the two incompressible liquids comprise contrasting densities and wherein the piston floats between the two incompressible liquids.

In an embodiment, each momentum wheel among the plurality of momentum wheels can comprise a propulsive momentum wheel.

In an embodiment, each momentum wheel among the plurality of momentum wheels can facilitate propulsion.

In an embodiment, the plurality of momentum wheels can convert an angular system to an angular system with vector.

In an embodiment, the center of mass can be separated from a center of geometry when one or more electromagnets is activated and the center of mass is united back in line with the center of geometry after one π radian.

In an embodiment, the momentum wheel(s) among the plurality of momentum wheels can shift into a vector mode for one π radian and a cycle period repeats.

In an embodiment, the electromagnet(s) can facilitate a movement of the piston asymmetrically and then bring the piston back into symmetry.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A gyral motor, comprising:
a plurality of momentum wheels wherein each momentum wheel among the plurality of momentum wheels comprises a cylinder within which a piston is located and enclosed within the cylinder by a cylinder cover; and
at least one electromagnet, wherein the momentum wheels among the plurality of momentum wheels while spinning are self-balanced until the electromagnet is activated.

2. The gyral motor of claim 1 wherein each momentum wheel among the plurality of momentum wheels comprises a propulsive momentum wheel.

3. The gyral motor of claim 1 wherein each momentum wheel among the plurality of momentum wheels facilitates propulsion.

4. The gyral motor of claim 1 the plurality of momentum wheels converts an angular system to an angular system with vector.

5. The gyral motor of claim 1 wherein the plurality of momentum wheels includes at least two momentum wheels that comprise two balanced and counter-rotating, aligned moment wheels during the spinning of the plurality of momentum wheels.

6. The gyral motor of claim 1 wherein a center of mass is separated from a center of geometry when the at least one electromagnet is activated and the center of mass is united back in line with the center of geometry after one π radian.

7. The gyral motor of claim 1 wherein at least one momentum wheel among the plurality of momentum wheels shifts into a vector mode for one π radian and a cycle period repeats.

8. The gyral motor of claim 1 further comprising two incompressible liquids positioned on each side of the piston.

9. The gyral motor of claim 8 wherein each of the two incompressible liquids comprise contrasting densities.

10. The gyral motor of claim 8 wherein the piston floats between the two incompressible liquids.

11. The gyral motor of claim 1 wherein the gyral motor moves curvilinearly through cycle periods.

12. The gyral motor of claim 1 wherein the at least one electromagnet facilitates a movement of the piston asymmetrically and then brings the piston back into symmetry.

13. The gyral motor of claim 1 wherein the plurality of momentum wheels comprises at least one outer momentum wheel and at least on inner momentum wheel.

14. A gyral motor, comprising:
a plurality of momentum wheels wherein each momentum wheel among the plurality of momentum wheels comprises a cylinder within which a piston is located and enclosed within the cylinder by a cylinder cover;
at least one electromagnet, wherein each of the plurality of momentum wheels while spinning are self-balanced until the at least one electromagnet is activated, wherein the plurality of momentum wheels comprise balanced and counter-rotating, aligned momentum wheels during the spinning of the plurality of momentum wheels; and
two incompressible liquids positioned on each side of the piston, wherein each of the two incompressible liquids comprise contrasting densities and wherein the piston floats between the two incompressible liquids.

15. The gyral motor of claim 14 wherein each momentum wheel among the plurality of momentum wheels comprises a propulsive momentum wheel.

16. The gyral motor of claim 14 wherein each momentum wheel among the plurality of momentum wheels facilitates propulsion.

17. The gyral motor of claim 14 the plurality of momentum wheels converts an angular system to an angular system with vector.

18. The gyral motor of claim 14 wherein a center of mass is separated from a center of geometry when the at least one electromagnet is activated and the center of mass is united back in line with the center of geometry after one π radian.

19. The gyral motor of claim 14 wherein at least one momentum wheel among the plurality of momentum wheels shifts into a vector mode for one π radian and a cycle period repeats.

20. The gyral motor of claim 14 wherein the at least one electromagnet facilitates a movement of the piston asymmetrically and then brings the piston back into symmetry.
